(19) United States
(12) Patent Application Publication
(10) Pub. No.: US 2012/0247634 A1
(43) Pub. Date: Oct. 4, 2012

(54) Stuffed Tire For Lightweight Vehicles

(76) Inventors: Gordon Liao, Tainan City (TW); Chun-Yi Leu, Taipei City (TW)

(21) Appl. No.: 13/076,503

(22) Filed: Mar. 31, 2011

(51) Int. Cl. B60C 7/00

(52) U.S. Cl. 152/310

(57) ABSTRACT

The present invention provides a stuffed tire for lightweight vehicles, comprising: a wheel; a tire casing, mounted onto the wheel; a harder elastic structure, installed inside the tire casing, and having an end abutted against the wheel; and a softer elastic filler, filled into the tire casing, and having an end abutted against another end of the harder elastic structure, so as to enhance the supporting strength of the tire and the balance of the rotating tire.

### BACKGROUND OF THE INVENTION

1. Field of the Invention

The present invention relates to a stuffed tire for lightweight vehicles, and more particularly to a stuffed tire capable of enhancing the supporting strength and the balance of the vehicles.

2. Description of the Related Art

Lightweight vehicle refers to a vehicle with the following conditions: 1. a vehicle having a lighter body; 2. a vehicle carrying a smaller load; and 3. a vehicle with tires that requires no inflation. For example, bicycles, golf carts, strollers, grocery carts, shopping carts, wheelchairs, and luggage trolleys are light weight vehicles. In a conventional stuffed tire for lightweight vehicles, an elastic foam filler is filled into the interior of the tire casing directly to substitute the use of a general air tube, but it is difficult to control the structural strength of the elastic filler and the uniformity of the filler inside the tire, and thus poor quality and defect may result easily. Furthermore, the conventional stuffed tire usually is manufactured with one hardness only. If the tire is too soft, then it will be unable to support the vehicle (or the supporting strength is poor). If the tire is too hard, then it will lack of elasticity and affect the balance of the rotating. Obviously, the conventional stuffed tires require improvements.

### SUMMARY OF THE INVENTION

Therefore, it is a primary objective of the present invention to overcome the shortcomings of the prior art by providing a stuffed tire for lightweight vehicles capable of enhancing the supporting strength and balance.

To achieve the foregoing objective, the present invention comprises: a wheel; a tire casing, mounted onto the wheel; a harder elastic structure, disposed inside the tire casing, and having an end abutted against the wheel; and a softer elastic filler, filled into the tire casing, and having an end abutted against another end of the harder elastic structure, so as to enhanced the supporting strength of the tire and the balance of the rotating tire.

### BRIEF DESCRIPTION OF THE DRAWINGS

FIG. 1 is a perspective exploded view of the present invention; and

FIG. 2 is a perspective cross-sectional view of the present invention.

### DETAILED DESCRIPTION OF THE PREFERRED EMBODIMENTS

To make it easier for our examiner to understand the technical characteristics and measures of the present invention to achieve the aforementioned objects and effects, we use preferred embodiments with related drawings for the detailed description of the present invention as follows.

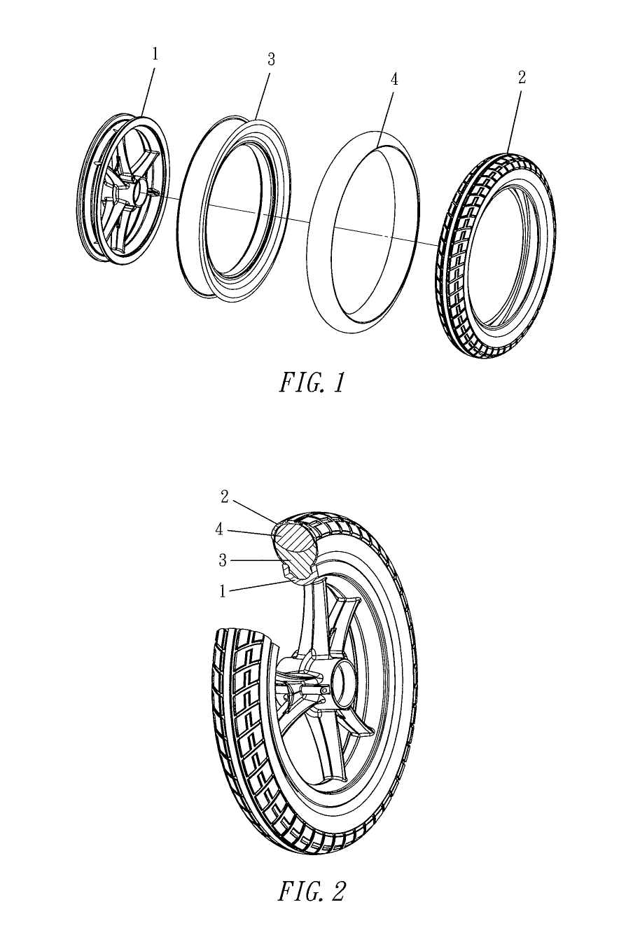

With reference to FIGS. 1 and 2, the present invention comprises:

a wheel 1, made of a hard plastic or metal material;

a tire casing 2, made of rubber, and mounted onto the wheel 1;

a harder elastic structure 3, made of an elastic foam material such as EVA, TPU and TPR, and disposed in the tire casing 2, and having an end abutted against the wheel 1; and a softer elastic filler 4, made of a liquid foam material such as PU and silicone, and filled in the tire casing 2, and having an end abutted against another end (which is the upper end) of the harder elastic structure 3.

In the aforementioned assembly of the present invention, the harder elastic structure 3 is stuffed between the wheel 1 and the tire casing 2 (that is inside the tire casing 2) to support the tire casing 2, and then the liquid foam is filled up into the gap between the tire casing 2 and the wheel 1 to form a softer elastic filler 4 for making the tire more secured. In other words, the harder elastic structure 2 is provided for assisting the support of the tire casing 2 to maintain the circularity of the tire and provide a specific structural strength, so as to enhance the supporting strength of the tire. In addition, the softer elastic filler 4 filled into the gap between the wheel 1 and the tire casing 2 can prevent water and mud from entering into the interior of the tire and provide a specific elasticity to the tire to improve the balance of the rotating tire. Obviously, the present invention improves over the prior art.

In summation of the description above, the present invention as disclosed in the preferred embodiments are novel and it achieves the expected objectives and effects and complies with the patent application requirements, and thus is duly applied for patent application.

What is claimed is:

1. A stuffed tire for lightweight vehicles, comprising:
a wheel;
a tire casing, mounted onto the wheel;
a harder elastic structure, disposed inside the tire casing, and having an end abutted against the wheel; and
a softer elastic filler, stuffed in the tire casing, and having an end abutted against another end of the harder elastic structure;
so as to enhance the supporting strength of the tire and the balance of the rotating tire.

2. The stuffed tire for lightweight vehicles as recited in claim 1, wherein the harder elastic structure is made of an elastic foam material selected from the collection of EVA, TPU, and TPR.

3. The stuffed tire for lightweight vehicles as recited in claim 1, wherein the softer elastic filler is made of a liquid foam material selected from the collection of PU and silicone.
